(19) United States
(12) Patent Application Publication
(10) Pub. No.: US 2013/0019761 A1
(43) Pub. Date: Jan. 24, 2013

(54) GRILL WITH ANTI-SHAKING STRUCTURE

(71) Applicants: Yixin ZHAN, Zhangzhou (CN); Ying Liu, Zhangzhou (CN)

(72) Inventors: Yixin ZHAN, Zhangzhou (CN); Ying Liu, Zhangzhou (CN)

(73) Assignee: TSANN KUEN (ZHANG ZHOU) ENTERPRISE CO., LTD., Zhangzhou (CN)

(21) Appl. No.: 13/551,049

(22) Filed: Jul. 17, 2012

(30) Foreign Application Priority Data
Jul. 18, 2011 (CN) 201120254036.4

(51) Int. Cl. A47J 37/06

(52) U.S. Cl. 99/380

(57) ABSTRACT

A grill with an anti-shaking structure has an upper pan and a lower pan, an upper heater and a lower heater for heating the upper pan and lower pan respectively. At least one shaft member having a shaft and a shaft base for containing the shaft is disposed between the upper and lower pan. The shaft base has a triangular shaft hole with a protrusion in a side of the triangle. The shaft passes through the triangular shaft hole and can be moved among the three angles for switching the use of the upper pan and lower pan. When the upper pan and the lower pan are unfolded to 180°, the shaft can be limited by the protrusion. The grill can be switched among three using status: 0°, 105° and 180°, and in each status both the upper pan and lower pan are stable.

### FIELD OF THE INVENTION

The present relates to a grill, more particularly, to a grill with anti-shaking structure.

### BACKGROUND OF THE INVENTION

Referring to FIG. 1, grill in the market usually comprises an upper pan 20 and a lower pan 10, and the two pans are heated by an upper heater and a lower heater respectively. In use, the two pans can be folded as a grill for grilling food, or be unfolded as two cooking pans. In unfolded status, it has position such as 105° or 180°. The upper pan 20 and lower pan 10 are rotatably connected by a pair of shaft members. Each of the shaft member comprises a shaft base 21 disposed on one end of the lower pan 2, and a shaft 11 disposed on one end of the upper pan 1. Herein an elongated hole 22′ extended on vertical direction is disposed on the shaft base 21, and the shaft 11 is moveably inserted in the hole 22′. When the upper pan and the lower pan are closed, the shaft 11 is in the upper end of the hole 22′; when the upper pan and the lower pan are unfolded to 180°, the shaft 11 is in the lower end of the hole 22′. However, because the shaft 11 can move up or down freely in the hole 22′, so in the 180°, the two shafts 11 disposed on the front side and rear side respectively can be moved in two holes 22′ respectively, thus the upper pan 1 may be shaken, and the oil with high temperature may be spilled out, or food may be fallen out.

### SUMMARY OF THE INVENTION

Therefore, the primary object of the present invention is to provide a grill with anti-shaking structure to obviate the problem in above.

This and other objects of the present invention are achieved by providing:

A grill with anti-shaking structure comprising an upper pan and a lower pan, and an upper heater and a lower heater for heating the upper pan and lower pan respectively, wherein at least a shaft member is disposed between the upper pan and the lower pan, said shaft member comprising a shaft and a shaft base for containing the shaft, said shaft base has a triangular shaft hole, said triangular shaft hole has a protrusion in a side of the triangle, and said shaft is passing through in the triangular shaft hole and can be moved among the three angles for switching the using status of the upper pan and lower pan.

In a preferred embodiment of the present invention, the triangle of said triangular shaft hole is an isosceles triangle.

In a preferred embodiment of the present invention, said protrusion is disposed between the two base angle of the isosceles triangle.

In a preferred embodiment of the present invention, one side of the equal sides of the isosceles triangle is vertical to the pan surface, and the vertex angle is on the top.

In a preferred embodiment of the present invention, three angles of the triangle are smoothing angles (not sharp).

In a preferred embodiment of the present invention, said shaft is fixedly connected to the upper pan, and the shaft base is fixedly connected to the lower pan.

In a preferred embodiment of the present invention, said shaft base comprises a triangular body connected to the edge of the lower pan via a connected rod; a first inclined plane is formed on the end of the connecting rod, beside the triangular body.

In a preferred embodiment of the present invention, said shaft comprising a shaft body inserted in the shaft hole and a L-shape body for fixedly connecting the shaft body to the pan; one end of the L-shaped body is fixed to the edge of the upper pan, and an second inclined plane is formed on the other end, the shaft body is disposed horizontally on the side of the L-shaped body.

In a preferred embodiment of the present invention, when said shaft body is disposed in different angles of the shaft hole, then the upper pan and lower pan are formed to be three using status: 0°, 105° and 180° respectively.

Therefore, the present invention provided a grill with anti-shaking structure, wherein at least a shaft member is disposed between the upper pan and the lower pan, said shaft member comprising a shaft and a shaft base for containing the shaft, said shaft base has a triangular shaft hole, said shaft hole has a protrusion in a side. When the upper pan and the lower pan are unfolded to 180°, the shaft can be limited by the protrusion, thus the upper pan and the lower pan can be stable. And the present invention has simple structure, and only needed to change the shaft hole of the prior art. The present can be switch among three using status: 0°, 105° and 180°, and in each status both the upper pan and lower pan are stable.

### BRIEF DESCRIPTION OF THE DRAWINGS

FIG. 1 is a front view of the grill in prior art;

FIG. 2 is a perspective view of the present invention;

FIG. 3 is an exploded view of the present invention;

FIG. 4 is a perspective view of the upper pan of the present invention;

FIG. 5 is a perspective view of the lower pan of the present invention;

FIG. 6 is a perspective view of the present invention in 180° status;

FIG. 7 is a front view of the present invention in 180° status;

FIG. 8 is a front view of the present invention in 150° status.

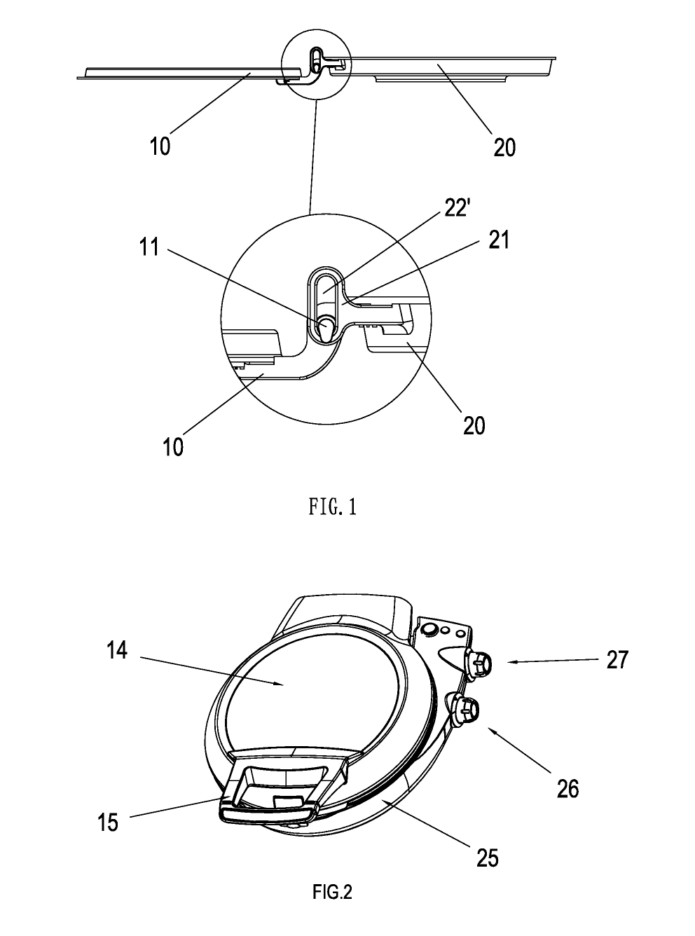

### DETAILED DESCRIPTION OF PREFERRED EMBODIMENT

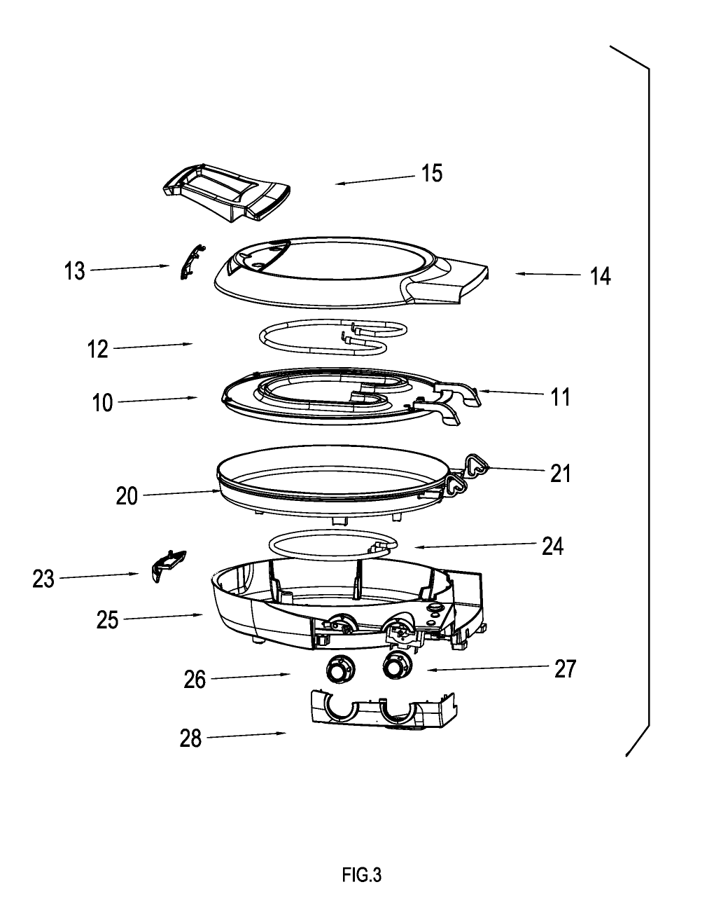

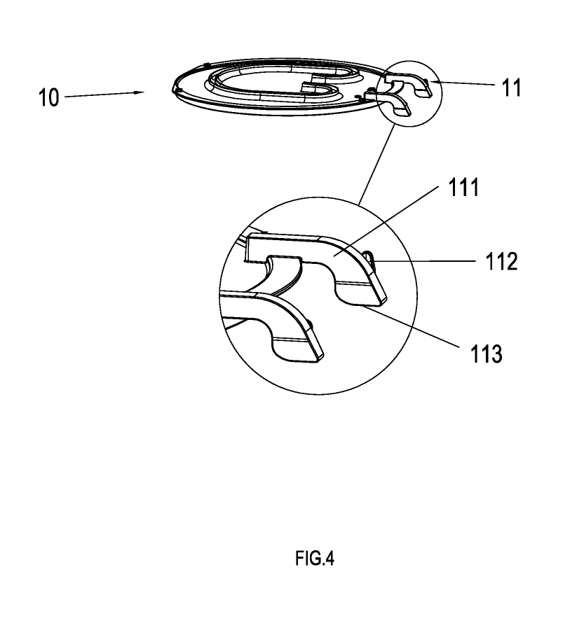

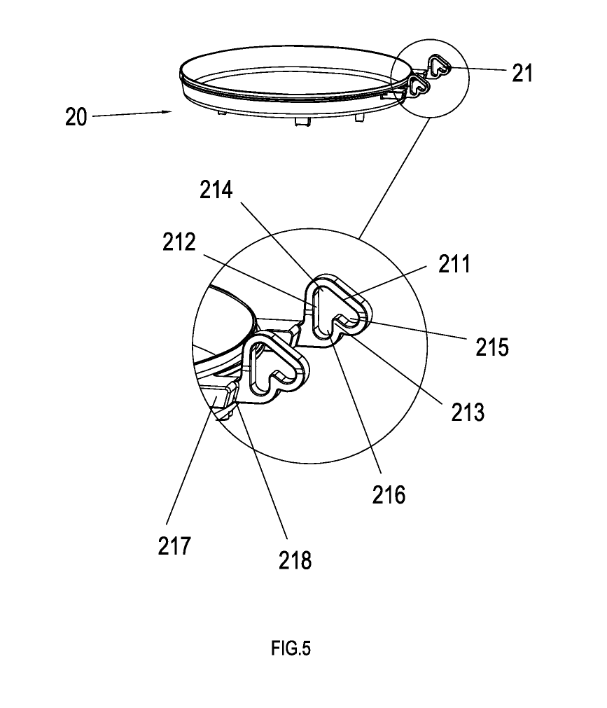

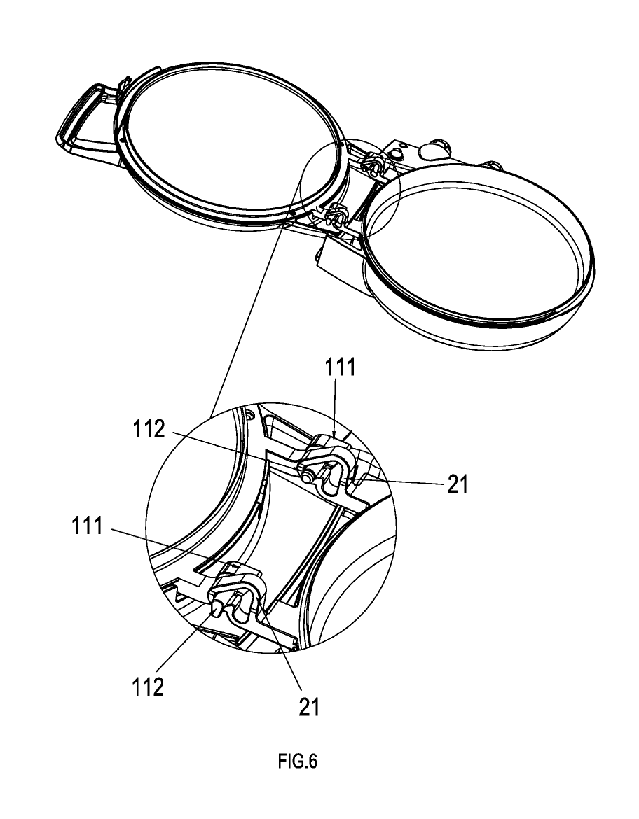

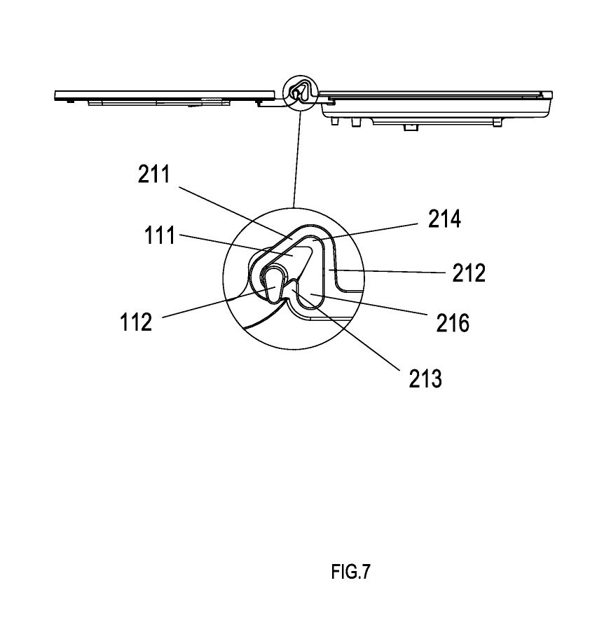

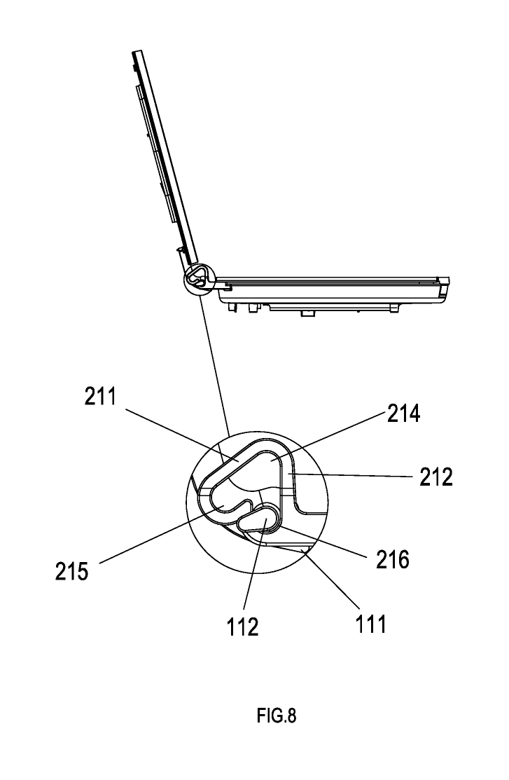

Referring to FIG. 2 to FIG. 8, The grill with anti-shaking structure comprises a lower shell 25, an upper shell 14, a lower pan 20 disposed on the top surface of the lower shell 25, and an upper pan 10 disposed on the bottom of the upper shell 14.

An electrical heating tube 12 for heating the upper pan is disposed between the upper shell 14 and the upper pan 10; an electrical heating tube 24 for heating the lower pan is disposed between the lower shell 25 and the lower pan 20. A handle 15 and a grip element 13 are disposed on one side of the upper shell 14. A grip cover 23 corresponding to the grip element 13 is disposed on the corresponding side of the lower shell 25. A temperature button 26, a time button 27 and a side cover 28 are disposed on the other side of the lower shell 25.

The key point of the present invention is that: the upper pan 10 and the lower pan 20 are connected by two shaft members. Each of the shaft member comprises a shaft 11 fixed on the edge of the upper pan 10, and a shaft base 21 fixed on the edge of the lower pan 20.

The shaft 11 comprises a L-shaped body 111 and a shaft body 112, one end of the L-shaped body is fixed to the edge of the upper pan 10, and the other end is formed a bottom 113, and the shaft body 112 is disposed horizontally to a side of the other end.

The shaft base comprises a triangular body 21 connected to the edge of the lower pan 20 via a connecting rod 217. An inclined plane 218 is formed on the end of the connecting rod 217, beside the triangular body 21. The triangular body 21 has a triangular hole, and the triangular hole has three smoothing angle 214, 215 and 216. The side 211 and side 212 have same length, and the third side has a protrusion 213, thus the hole is formed a heart-shape. The shaft body 112 is inserted in the hole, and can be moved along 215-214-216 direction or in reverse. Herein the side 212 is vertical to the lower pan surface, and the vertex 214 is on the top.

In use, if the upper pan and the lower pan are needed to be unfolded, then insert the shaft body 112 of the shaft 11 of the upper pan in the vertex 214, in this position the grill is in 0° status.

Turn up the upper pan 10, and the shaft body 112 of the shaft 11 of the upper pan 10 is disposed in the angle 216 of the triangular body 21 of the shaft base of lower pan, the inclined plane 113 of the L-shaped body 111 of shaft 11 is abut against the inclined plane 218 of the connecting rod 217, in this position, the grill is in 105° status (referring to FIG. 8). By the action between the inclined plane 113 and the inclined plane 218, and the limitation of the angle 216 to the shaft body 112, the upper pan is stable.

Lift the upper pan 10, the shaft body 112 of the shaft 11 of the upper pan 10 is removed from the angle 216 of the triangular body 21, and inserted to another angle 215, because the incline plane 113 and inclined plane 218 are released, the grill can be unfolded to 180°. In 180° status, the shaft body 112 of the shaft 11 of the upper pan 10 is disposed in the angle 215. By the limitation of the side 211, protrusion 213 and angle 215, the shaft 11 is limited in the angle 215, and will not move up or down. By action of the weight of the upper shell and pan, the shaft 11 in the angle 215 will not move to left or right direction also.

In 180° status, if the upper pan 10 is lift, and the shaft body 112 is disposed in the angle 216, and the plane 113 of the L-shaped body 111 is abut against the plane 218 of the connecting rod 217, then grill is return to 105° status; if the upper pan is lift, and the plane 113 of the L-shaped body 111 is depart from the plane 218 of the connecting rod 217, the shaft body 112 is disposed in angle 214, the upper pan can be cover on the lower pan 20, and the grill will return to 0° status again.

Certainly, when the upper pan and lower pan is in 180°, if the upper pan 10 is lift, and let the shaft body 112 to be disposed in angle 214, then the upper pan 10 can be cover on the lower pan 20 directly, then the status of the grill can be return to 0° status, need not a middle 105° status. Vice versa, the upper pan and lower pan can be reach to 180° status from 0° status directly.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with detailed description, but rather by the claims appended hereto.

1. A grill with anti-shaking structure comprising an upper pan and a lower pan, an upper heater and a lower heater for heating the upper pan and lower pan respectively, wherein at least a shaft member is disposed between the upper pan and the lower pan, said shaft member comprising a shaft and a shaft base for containing said shaft, said shaft base has a triangular shaft hole, said triangular shaft hole has a protrusion in a side of the triangle, said shaft is passing through in the triangular shaft hole and can be moved among the three angles for switching the using status of the upper pan and lower pan.

2. The grill with anti-shaking structure according to claim 1, wherein the triangle of said triangular shaft hole is an isosceles triangle.

3. The grill with anti-shaking structure according to claim 2, wherein said protrusion is disposed between the two base angles of the isosceles triangle.

4. The grill with anti-shaking structure according to claim 2, wherein one side of the equal sides of the isosceles triangle is vertical to the pan surface, and the vertex angle is on the top.

5. The grill with anti-shaking structure according to claim 1, wherein three angles of the triangle are smooth.

6. The grill with anti-shaking structure according to claim 1, wherein said shaft is fixedly connected to the upper pan, and the shaft base is fixedly connected to the lower pan.

7. The grill with anti-shaking structure according to claim 1, wherein said shaft base comprises a triangular body connected to the edge of the lower pan via a connected rod; a first inclined plane is formed on the end of the connecting rod, beside the triangular body.

8. The grill with anti-shaking structure according to claim 7, wherein said shaft comprising a shaft body inserted in the shaft hole and a L-shape body for fixedly connecting the shaft body to the pan; one end of the L-shaped body is fixed to the edge of the upper pan, and a second inclined plane is formed on the other end, the shaft body is disposed horizontally on the side of the L-shaped body.

9. The grill with anti-shaking structure according to claim 8, wherein when said shaft body is disposed in different angles of the shaft hole, then the upper pan and lower pan are formed to be one of three using status: 0°, 105° and 180° respectively.
